(19) United States
(12) Patent Application Publication
(10) Pub. No.: US 2006/0107229 A1
(43) Pub. Date: May 18, 2006

(54) Work area transform in a graphical user interface

(75) Inventors: David A. Matthews, Seattle, WA (US); Charles W. Stabb, Seattle, WA (US); Kanwal Vedbrat, Seattle, WA (US); Mark R. Ligameri, Snohomish, WA (US)

Correspondence Address: BANNER & WITCOFF LTD.,;ATTORNEYS FOR MICROSOFT, 1001 G STREET , N.W., Suite 1100, WASHINGTON, DC, 20001-4597, US

(73) Assignee: Microsoft Corporation, Redmond, WA (US)

(21) Appl. No.: 10/986,950

(22) Filed: Nov. 15, 2004

(51) Int. Cl. G06F 17/00

(52) U.S. Cl. 715/782

(57) ABSTRACT

A method and apparatus for transforming a work area and displaying an information component in a graphical user interface is provided. The graphical user interface utilizes a three-dimensional transformation to move a presently displayed work area, for example a desktop with open windows, revealing a background presentation area behind it. In the portion of the presentation area revealed, an information component, such as a Start Menu, is displayed. Use of the three-dimensional transformation effectively decouples an operating system from the applications it hosts. The transformation further prevents visual clutter by separating the information component from the previously underlying desktop.

### FIELD OF THE INVENTION

The invention relates generally to computer operating systems. More specifically, the invention provides a method for transforming a work area (e.g., desktop) of a graphical operating system in a virtual three-dimensional space to view an information component in the revealed presentation area.

### BACKGROUND OF THE INVENTION

Computer operating systems have evolved significantly in recent years. Typically, these systems have a shell that provides a graphical user interface (GUI) to an end-user. The shell consists of one or a combination of software components that provide direct communication between the user and the operating system. Speed improvements in computer hardware, e.g., memory, hard drives, processors, graphics cards, system buses, and the like, have enabled richer GUIs that are drastically easier for users to comprehend. Accompanying hardware price reductions have made computer systems more affordable, enabling broad adoption of computers as productivity tools and multimedia systems. GUIs have allowed users who may have been unschooled or unfamiliar with computers to quickly and intuitively grasp the meaning of desktops, icons, windows, and applications, and how the user can interact with each.

The desktop illustrated in FIG. 2 has become the standard graphical metaphor for modern GUIs. The interface is designed to model the real world activity of working at a desk. The desktop typically occupies the entire surface of a single display device, or may span multiple display devices, and hosts subordinate user interface objects such as icons, menus, cursors and windows. The desktop serves as a base work area, where multiple documents and applications can sit open. To draw this virtual work area, the operating system uses a simulated three-dimensional layering of windows and desktop drawn in a two dimensional graphical space, sometimes referring to this layering as Z-ordering. The term Z-order is derived from three dimensional (3D) geometry, where the horizontal axis is typically known as the X-axis, the vertical axis is the Y-axis, and the Z axis sits perpendicular to the plane formed by the X and Y axes. Hence, the Z-order value for each window refers to that window's relative position along an axis perpendicular to the desktop. Ultimately, Z-ordering is used to draw the two dimensional display, by determining which object is on top when two objects overlap. The operating system shell draws the object with the higher Z-order value, and subsequently draws the area of the second object not covered by the first object. Although Z-ordering is nominally derived from 3D geometry, the method only minimally exploits in two dimensions the capabilities inherent in having a true third Z dimension.

To some extent, this two-dimensional shortcoming has been driven by the video hardware available in personal computers. In the past, advancements in mid- and lower-end computer video hardware have been driven in large part by the graphical services available in popular operating systems. However, the graphical services available in these systems have not significantly advanced for a variety of reasons, including the need to maintain compatibility with older application software and the limited capabilities of the affordable range of video hardware. More recently, however, real-time 3D computer games have overtaken operating systems as the primary market incentive for advancing retail video hardware, which has in a short time attained an exceptional level of sophistication. Real time, hardware-based 3D acceleration is now available to consumers at reasonable cost. Thus, graphics hardware features once considered highly advanced, such as accelerated texture and lighting algorithms as well as 3D transformations are readily available. At present, generally only game software and highly specialized graphics applications actively exploit such features.

An operating system, such as Microsoft Windows XP® brand or Windows 2000® brand operating systems, will typically comprise a graphical method for launching new software applications within its GUI. FIG. 2 illustrates a well-known example of how this may be accomplished in the Windows 2000 operating system. The screenshot 200 displays desktop 201, bordered on one side by taskbar 203, and featuring open window 202. When a user desires to launch a new application, the user moves a pointer (also known as a cursor) controlled by a mouse and clicks on the appropriate menu item in the Start Menu 204, which is itself first invoked by clicking on the Start button 205. The Start button 205 is generally located in a fixed location on the taskbar 204. A user may adjust the location of the taskbar 203, but once in place, the Start button 205 becomes a constant and familiar starting point for the user to launch new applications.

When a user clicks on the Start button 205 in FIG. 2, the Start Menu 204 appears as a floating list on top (i.e., has a higher Z-order value) of the currently open window 202 and desktop 201. A subsequent submenu 206 of the Start Menu 204, here triggered when the user clicks on or hovers over the “Programs” list item, appears on top of and to the right of the original Start Menu in order to show more choices. Only when the user finally clicks on the desired application in the Start Menu 204 or submenu 206 do the Menu and submenus disappear. In the meantime, the user may be confused by the flat and overlapping menus and windows which together create a crowded stack of information. In addition, any content under the Start Menu 204 and submenu(s) 206 is completely hidden from the user, preventing viewing of and interaction with obscured content.

Using a broader perspective, a program launching menu, like the Start Menu, occupying the same work area as the software applications inhibits a user's fundamental understanding of the operating system. Manipulating application windows and the content therein can be viewed as tasks within and under the auspices of the operating system. For these tasks (e.g. editing a document or clicking on a link in a web page) the operating system can be viewed as arbitrating communication between the user and the application, displaying application output for the user, and passing user input to the application. Using this same perspective, launching a new application can be viewed as a meta-task, or as making a direct request of the operating system which operates outside the normal user-input-application-output model. That being the case, a program launching menu which occupies an existing work area inhabited by other windows and icons has the potential to confuse an end user, both visually and conceptually.

Thus, it would be an advancement in the art to provide for viewing a program launching menu in a way which does not clutter a work area such as a desktop, and also conceptually decouples the operating system from the applications it hosts.

### BRIEF SUMMARY OF THE INVENTION

The following presents a simplified summary of the invention in order to provide a basic understanding of some aspects of the invention. The summary is not an extensive overview of the invention. It is not intended to identify key or critical elements of the invention or to delineate the scope of the invention. The following summary merely presents some concepts of the invention in a simplified form as a prelude to the more detailed description below.

A first embodiment of the invention provides a method for displaying content to a user through a three-dimensional graphical user interface on a computer. The method comprises transforming a presently displayed work area, which includes desktops, windows, and the like. The transformation can involve rotating the work area away from the user and revealing a portion of a presentation area situated behind the work area. Finally, an information component, such as a Start Menu, is displayed in the visible portion of the presentation area.

A second embodiment of the invention provides a computer system comprising a pointing device, a processor, a display, and a memory, the memory storing computer executable instructions. The computer executable instructions provide for a graphical user interface using three-dimensional graphics. In addition, the computer executable instructions provide for transforming a presently displayed work area, and displaying an information component in the portion of the presentation area revealed behind the work area.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1A illustrates an operating environment that may be used for one or more aspects of an illustrative embodiment of the invention.

FIG. 1B illustrates a distribution of functions and services among components that may be used for one or more aspects of an illustrative embodiment of the invention.

FIG. 2 is a screenshot depicting a prior art example of a program launching menu in a computer operating system graphical user interface.

FIG. 3A is a screenshot depicting an illustrative embodiment of the invention.

FIG. 3B illustrates a wire frame version of the screenshot in FIG. 3A.

FIG. 4A illustrates a top view of a virtual presentation area prior to utilizing an illustrative embodiment of the invention.

FIG. 4B illustrates a frontal view of the virtual presentation area of FIG. 4A as viewed by a user.

FIG. 5A illustrates a top view of a virtual presentation area showing an illustrative embodiment of the invention.

FIG. 5B illustrates a frontal view of the virtual presentation area of FIG. 5A as viewed by a user.

FIG. 6A illustrates a top view of a virtual presentation area showing an illustrative embodiment of the invention.

FIG. 6B illustrates a frontal view of the virtual presentation area of FIG. 6A as viewed by a user.

FIG. 7A illustrates a top view of a virtual presentation area showing an illustrative embodiment of the invention.

FIG. 7B illustrates a frontal view of the virtual presentation area of FIG. 6A as viewed by a user.

FIG. 8 illustrates a portion of a frontal view of an illustrative embodiment of the invention.

FIG. 9 illustrates a portion of a frontal view of an illustrative embodiment of the invention.

FIG. 10 illustrates a method for displaying an information component in a graphical user interface according to an illustrative aspect of the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

Illustrative Operating Environment

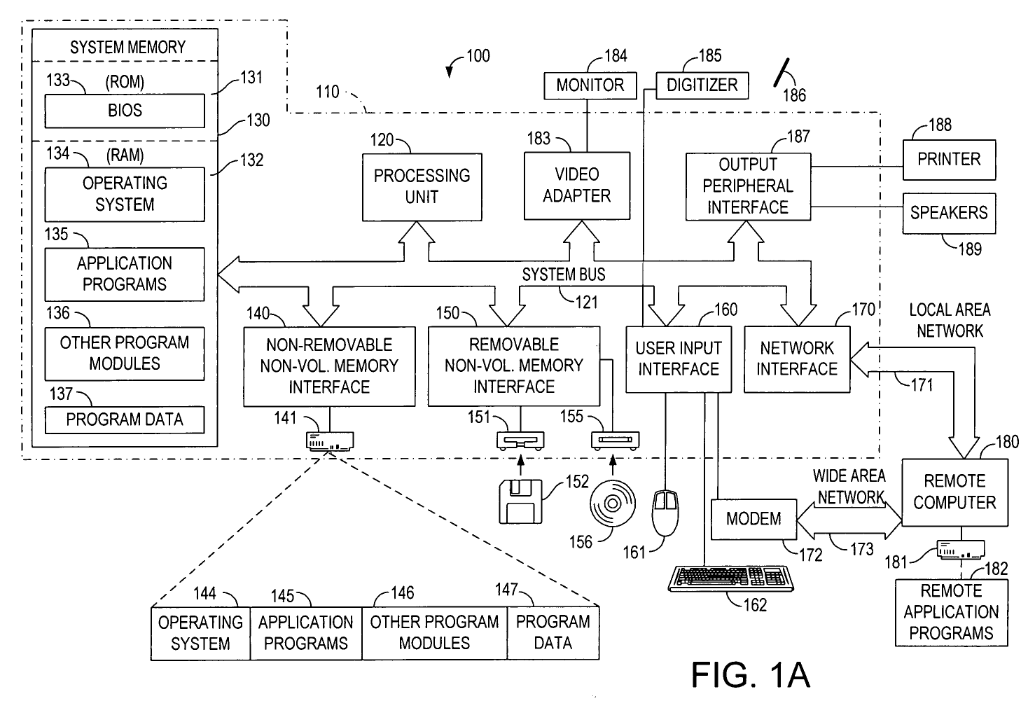

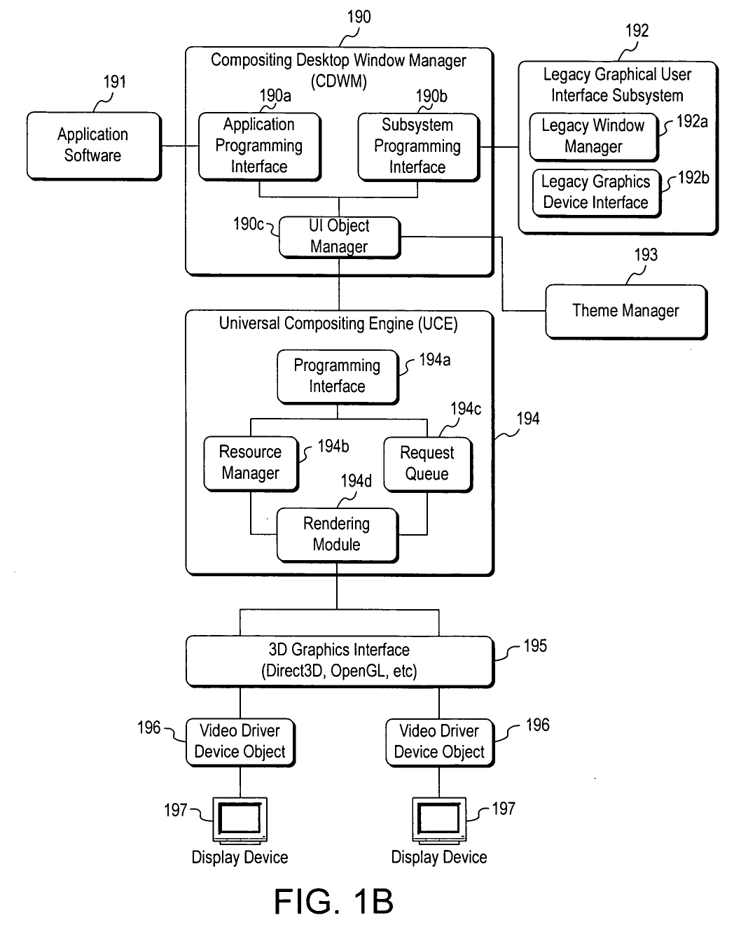

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers; server computers; portable and hand-held devices such as personal digital assistants (PDAs), tablet PCs or laptop PCs; multiprocessor systems; microprocessor-based systems; set top boxes; programmable consumer electronics; network PCs; minicomputers; mainframe computers; distributed computing environments that include any of the above systems or devices; and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an illustrative system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Advanced Graphics Port (AGP) bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, DVD or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, DVD, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port, universal serial bus (USB), or IEEE 1394 serial bus (FireWire). A monitor 184 or other type of display device is also connected to the system bus 121 via an interface, such as a video adapter 183. The video adapter 183 may comprise advanced 3D graphics capabilities, in addition to its own specialized processor and memory. Computer 110 may also include a digitizer 185 to allow a user to provide input using a stylus input device 186. In addition to the monitor, computers may also include other peripheral output devices such as speakers 189 and printer 188, which may be connected through an output peripheral interface 187.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 182 as residing on memory device 181. It will be appreciated that the network connections shown are exemplary and other means of establishing a communications link between the computers may be used.

### ILLUSTRATIVE EMBODIMENTS

The invention may use a compositing desktop window manager (CDWM), further described below and in co-pending application Ser. No. 10/691,450, filed Oct. 23, 2003 and entitled “Compositing Desktop Window Manager.” The CDWM is used to draw and maintain the display using a composited desktop model, i.e., a bottom-to-top rendering methodology in a virtual three-dimensional graphical space, as opposed to simulated 3D in a two-dimensional graphical space. The CDWM may maintain content in a buffer memory area (for future reference). The CDWM composes the display by drawing from the bottom up, beginning with the presentation area background, then a desktop background and proceeding through overlapping windows in reverse Z order. While composing a desktop, the CDWM may draw each window based in part on the content in front of which the window is being drawn (e.g., transparency), and based in part on other environmental factors (e.g., light source, reflective properties, etc.). For example, the CDWM may use the alpha channel of an ARGB format texture to provide transparency to a window, and may selectively emphasize portions of window content (e.g., the frame) based on a virtual light source.

The CDWM may rely upon a lower level graphics compositing subsystem, referred to herein as a Unified Compositing Engine (UCE), further described below and in co-pending application serial number (attorney docket number 50037.201US01), filed Oct. 23, 2003, entitled “System and Method for a Unified Composition Engine in a Graphics Processing System”, herein incorporated by reference in its entirety for all purposes. In one illustrative embodiment the UCE is based on or uses Direct3D® and DirectX® technology by Microsoft Corporation of Redmond, Wash. In alternative embodiments other graphics compositing subsystems may be used, such as variations of the X Window platform based on the OpenGL® graphics engine by Silicon Graphics, Inc. of Mountain View, Calif., and the like. The UCE enables 3D graphics, animation, transparency, shadows, lighting effects, bump mapping, environment mapping, and other rich visual features on the desktop.

FIG. 1B illustrates a component architecture according to an illustrative embodiment of a desktop composition platform. A Compositing Desktop Window Manager (CDWM) 190 may include an Application Programming Interface 190a through which a composition-aware Application Software 191 obtains window and content creation and management services; a Subsystem Programming Interface 190b, through which the Legacy Windowing Graphics Subsystem 192 interacts; and a UI Object Manager 190c which maintains a Z-ordered repository for UI objects such as presentation areas, work areas, desktops, windows and their associated content. The UI Object Manager may communicate with a Theme Manager 193 to retrieve resources, object behavioral attributes, and rendering metrics associated with an active interface theme. The Legacy Graphical User Interface Subsystem 192 may include a Legacy Window Manager 192a and Legacy Graphics Device Interface 192b.

A Unified Compositing Engine (UCE) 194 may service rendering instructions and coalesce resources emitted from the CDWM via a Programming Interface 194a. The UCE Programming Interface 194a provides an abstract interface to a broad range of graphics services including resource management, encapsulation from multiple-display scenarios, and remote desktop support. Rendering desktops to multiple displays requires abstraction of the differences in refresh rate, pixel format support, and device coordinate mapping among heterogeneous display devices. The UCE may provide this abstraction.

Graphics resource contention between write operations and rendering operations may be arbitrated by an internal Resource Manager 194b. Requests for resource updates and rendering services are placed on the UCE's Request Queue 194c by the Programming Interface subcomponent 194a. These requests may be processed asynchronously by the Rendering Module 194d at intervals coinciding with the refresh rate of the display devices installed on the system. Thus, the Rendering Module 194d of the UCE 194 may access and manipulate resources stored in the Resource Manager 194b as necessary, and assemble and deliver display-specific rendering instructions to the 3D Graphics Interface 195.

The UCE may also be responsible for delivering graphics data over a network connection in remote display configurations. In order to efficiently remote the display of one particular system to another, resource contention should be avoided, performance optimizations should be enacted and security should be robust. These responsibilities may also rest with the UCE.

The 3D Graphics Interface 195 may include a low-level, immediate-mode (stateless) graphics service such as Direct3D®, OpenGL®, or the like. A purpose of the 3D Graphics Interface may be to provide an abstract interface over the features of the particular graphics hardware configuration. The 3D Graphics Interface may service a single display device; the UCE may parse and distribute rendering instructions among multiple graphics output devices 197 in a multiple-display system via multiple device drivers 196.

It should be noted that the component architecture depicted in FIG. 1B is that of an illustrative embodiment. The figure is intended to illustrate functions that the invention may include. These functions may be distributed among a fewer or greater number of software components than those represented in the figure, according to the capabilities of the platform and the desired feature set. For example, a system that lacks theme management might derive all stock resources from the system rather than from a separate theme manager. Another possible variation may eliminate the Subsystem Programming Interface 190b if legacy application compatibility is not required. The subcomponents of the UCE 194 depicted in FIG. 1B may be broken out into separate processes, folded into the CDWM, or integrated into the 3D Graphics Interface. Thus a wide range of particular component designs are possible, each of which are capable of fulfilling either the entire range or a subset of the functions comprising the invention.

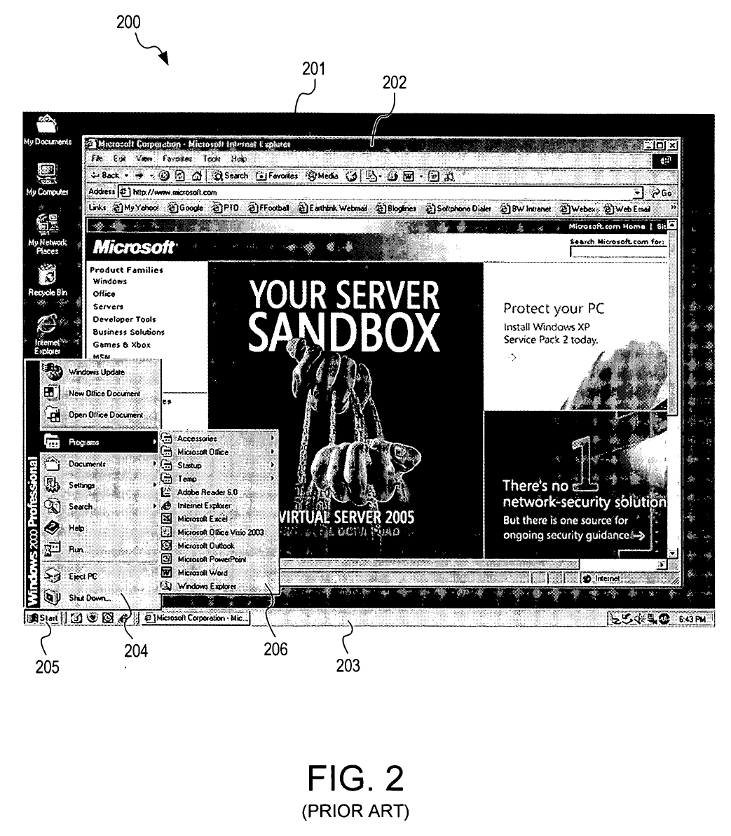

FIG. 3A depicts a screenshot according to an illustrative embodiment of the invention. FIG. 3B illustrates a similar embodiment drawn in wire frame for ease of reference. Here, invoking a Start Menu 301 by clicking Start button 306 has caused work area 302 to visually tilt away from the user, exposing a portion of a presentation area 303 in the background, and displaying the Start Menu in the revealed space. A work area as used herein refers to any space for collecting open windows and other user interface objects. At a minimum, a work area may comprise a single application or system tool taking up the entire display, but a typical work area can include a desktop 307 with a task bar 304 and one or more open windows 305. A presentation area 303, as used herein, refers to an entire virtual three-dimensional space in which objects, windows, desktops, and the like may be drawn, and may comprise the area behind the work area 302 that is not always visible to the user. The presentation area is conceptually associated with the operating system as opposed to being confused with any particular application. This association can be emphasized by including colors, logos, animations and/or other branding elements in the presentation area in order to more fully differentiate the operating system from a work area.

Although the illustrative embodiments of FIGS. 3A and 3B depict the visual tilt of the work area when invoking the operating system's program launcher, other types of information components may be suited for this visual effect. For example, controlling the computer's connection to a network is another task closely associated with the operating system, and as such, the appropriate network control interface may appear in the portion of the presentation area revealed when the interface is invoked and the currently displayed work area is transformed. Other examples of information components may include a clock, a file manager, an application un-installer, a task manager, a network dialog, a printer dialog, or any other component associated with the operating system. Optionally, each of these information components may also be launched into their own work areas.

Returning to FIG. 3B, once a user clicks on the Start button 306, and the work area 303 has been transformed, the user may choose a next course of action. The user can point to the appropriate item on the Start Menu 301 to launch a new application, or the user can point the mouse back onto the presently transformed work area 302 and click. If the user opts to click in the transformed work area 302, the work area can be “un-transformed” back into the forefront, giving the focus once again to the working application(s) therein. However, if the user decides to launch a new application, there are a number of possibilities for its handling. The user may opt to launch the new application within its own work area, creating a new work area within the presentation area and bringing the new work area into the forefront. This single application work area might commonly be associated with 3D games and other programs which control the entire screen. Alternatively, the user may opt to launch the application directly into the transformed work area 302, causing the work area to un-transform back to the forefront, and launching the new window in the presently displayed work area. Optionally, the decision whether to launch an application into its own work area or into an existing work area can be made automatically by the operating system, or by a previously set user preference associated with the application.

Transforming the presently displayed work area can be accomplished using a 3D graphics system present in the hardware and/or software (e.g., in the operating system) of the host computer, as described above. Optionally, ongoing visual activity within the transformed work area may continue while transformed, especially with the assistance of the 3D graphics system. For example, if a window within the work area is showing a video clip, the video may continue to play, although in a transformed state. When a user clicks on the Start button, the operating system uses a three dimensional transform to tilt the work area. The specifics of this transformation are provided in more detail below. Although a three dimensional rendering system is used here, the visual transformation can be simulated by conventional two-dimensional algorithms. The resulting display conceptually decouples the operating system from the applications it hosts and prevents visual clutter while taking full advantage of the graphics capabilities of the host computer.

Once the presently displayed work area is transformed and the information component displayed, the work area may retain some level of interactivity. At a minimum, if the user points the mouse in the work area and clicks, the work area can be returned to its initial un-transformed state, and the user may resume normal manipulation of the work area. Alternatively, the location of the user's click may be processed as a normal click upon the screen, triggering activity within the work area. For example, clicking on a window in the transformed work area might bring the work area back into the forefront, and additionally give the focus to the window clicked while the work area was transformed. Another possibility is that the user may click on a specific control or item within an application window in the transformed work area. The exact location of the click can be un-transformed into two-dimensional space and passed through to the application running within the work area. The work area can be returned to the forefront, and the application can process the click as it normally would.

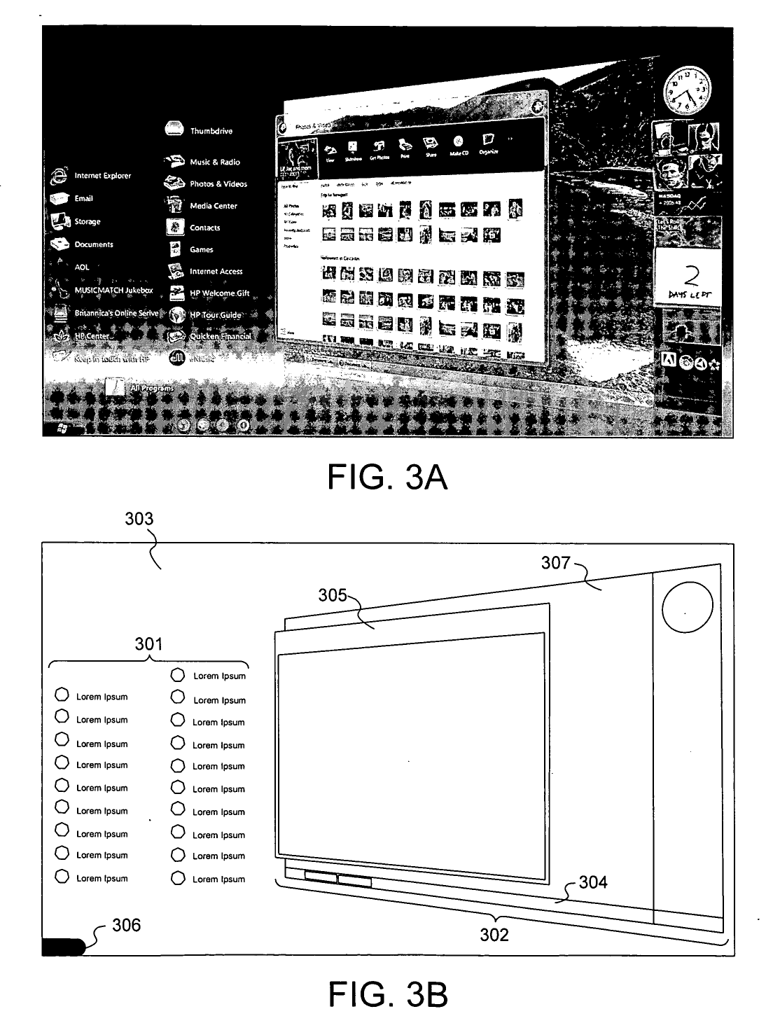

FIG. 4A illustrates a top view of a virtual presentation area utilized in an illustrative embodiment of the invention. FIG. 4B illustrates a frontal view of the virtual presentation area of FIG. 4A. The presentation area 401 is virtual in that it doesn't physically exist; it is a virtual 3D space in which items can be presented to a user. Rather, the top view is used as an aid to visualize what occurs in the 3D graphics system when the Start button 405 is clicked by the user with a mouse or other pointing device. Here, the presentation area 401 is similar to the backstage area in a theater. The audience can view the contents of the presentation area 401 through the screen 402, with the sides of the display 403 outlining the screen. The audience viewpoint is depicted in FIG. 4B, which is the same view a user would see in the monitor display. The 3D scene in FIG. 4A is set in order to create the 2D view shown in FIG. 4B.

Mapping elements of work area 411 into 3D space can be accomplished in any number of ways, for example, using the resources of the previously described compositing desktop window manager, low level graphics APIs, such as Direct3D® or OpenGL®, a high level graphics API, such as Java 3D™, or working directly with the specialized hardware of a 3D graphics video card. One possible method for creating the 3D scene presented in FIGS. 4A and 4B is through modeling and rendering. Modeling each of the items associated with a conventional 2D desktop as a 3D scene starts with a series of 3D meshes. A mesh in 3D graphics is a collection of flat geometric primitives (frequently triangles) mapped into 3D space, each shape's vertices being assigned X, Y, and Z coordinates. The collection of several interconnecting primitives forms the mesh or exoskeleton of a 3D object, such as a teapot, a sphere, or a flat desktop. Once a mesh is created for an object, the surfaces of that object can be further defined in several ways, for example, by specifying properties (color, alpha transparency, texture, luminosity, reflectivity, etc.) and/or through a process called texture mapping, where a 2D image is folded and/or clipped onto a 3D mesh.

The meshes required to produce the scene set in FIGS. 4A and 4B may be fairly simple to generate. At a minimum, each of the items displayed can be a single polygon. In a more complicated setting, the elements of the scene may have complicated meshes which specify curved edges and complicated textures. Regardless, referring again to the top view in FIG. 4A, desktop 404 at a minimum may require a single flat rectangle. Likewise for open window 406. Note, however, that these two elements do not co-exist on the same plane. Rather the two meshes are separated in 3D space, each having a different Z coordinate position. In the top view, the screen 402 may be zero on the Z axis. Depending on the coordinate system in use, Z coordinate values may be positive going into the screen, or negative going into the screen. Regardless, if the screen 402 is zero, then objects with Z coordinates closest to zero will be in front of objects with Z coordinates further from zero. Here, open window 406 has a smaller Z coordinate than desktop 404. Likewise, Start button 405, being in front of everything in the scene, has an even smaller Z coordinate value. Dashboard item 407 has a Z coordinate value in between desktop 404 and open window 406.

Each of the meshes described above can be created in the host computer's 3D system using a 3D graphics API, such as Direct3D®, simply by specifying the X, Y, and Z coordinates of the vertices. Once described and placed, the surfaces of the meshes are defined. The desktop 404, for example may be a simple texture map of a photograph, or a single solid color with no transparency. The contents of open window 406 may be projected onto its respective mesh as a texture map, or each component of the open window can be drawn as its own mesh, each with its own attendant image and surface properties.

Once the surfaces are specified for each of the meshes, the scene is set in the memory of the computer. Next, the computer must render the 2D audience view (FIG. 4B) based on the 3D model in memory. This step may involve resolving lighting and shadows and determining which meshes are in front. Here, the presentation area is set with work area 411, comprising desktop 404, task bar 409, quick launch menu 408, open window 406, and dashboard item 407 (e.g., a persistent desktop control, such as a clock, included as part of a “dashboard” of controls). Although in the frontal view of FIG. 4B, work area 411 appears to the user to be a standard flat desktop, it is clear in the virtual top view of FIG. 4A that these items are virtually depicted in 3D space. The presentation area 401, while visible in the top view, is not currently viewable in the user's frontal view (FIG. 4B), since work area 411 obscures that portion of the 3D scene. Potentially, other items may be present in the virtual “backstage” area of presentation area 401, such as additional work areas, branding elements like background scenes, photographs, animations, etc., or individual information components. These items are not currently viewable to the user, however, again because work area 411 obscures the view. As such, the rendering step of the drawing process may need not concern itself with items behind the desktop 404.

Although the scene above is described as being set in 3D space, it is only one embodiment of the invention. The frontal view illustrated in FIG. 4B may also be created using conventional 2D systems, perhaps using much less computing power. The purpose of setting up the 3D scene is primarily to describe an embodiment of the invention described in more detail below and illustrated in other figures.

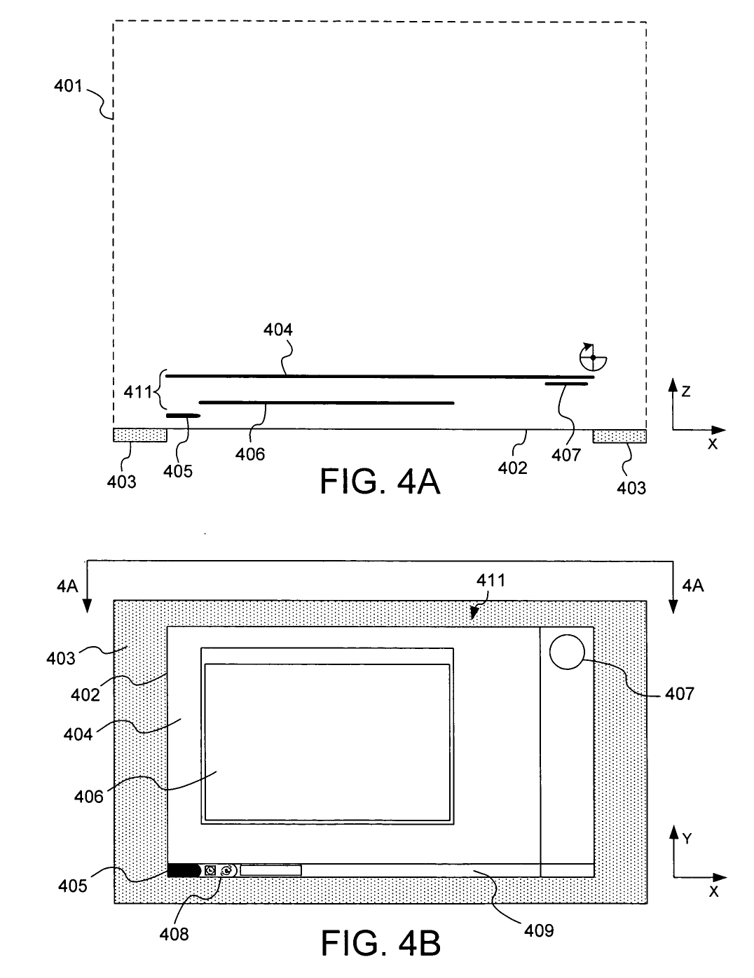

FIG. 5A illustrates a top view of a virtual presentation area showing an illustrative embodiment of the invention. As with FIGS. 4A and 4B, FIG. 5B illustrates a frontal view of the virtual presentation area of FIG. 5A as viewed by a user. Here, the 3D work area 411 has been transformed within the virtual presentation area 401, creating a frontal view that is remarkably different. The event triggering this transformation in the embodiment presented here is a user using a mouse or other pointing device to click on the Start button 405. However, many other events may trigger a similar transformation, including a sequence of keyboard strokes, the pressing of a hot button, a vocal command, the launching of an information component, or any other action by the user associated with the operating system. Here, when the user clicks the Start button 405, the program launcher 512 is set to appear, but the desktop must first be moved aside.

The transformation shown here is one of rotating the work area 411 away from the user around an invisible axis 510, the axis in this embodiment running parallel to the Y axis. Other axes of rotation are possible, including horizontal and diagonal axes and can be located in either in or outside of the presentation area. In addition, the particular transformation need not be a rotation; the work area may retreat from the screen and move to one side, for example. A 3D graphics API, such as Direct3D®, can accomplish this displacement of selected objects in the presentation area 401 with a transformation command, and the new scene or scenes can be rendered for presentation to the user. Optionally, the work area 411 is rotated away in one frame, without animation. However, in order to help the user mentally transition from the work area context to the operating system context, a smooth animation is preferred. The steps between FIGS. 4A/4B and FIGS. 5A/5B can be animated by rotating the work area 411 around axis 510 in small increments and rendering each of the frames in between.

Start button 405, as depicted here, in this embodiment does not move with the rotation. Rather, it retains its fixed location so that the user always sees it as a starting point and positional reference within the 3D presentation area 401. It should be noted that Start button 405 may be situated at any location within the display, and not just the lower left corner. For instance, the button 405 may be placed on the right side of the screen. In such a situation, the rotational transformation may optionally occur with work area 411 rotating away to the left rather than to the right.

As the work area 411 is rotated away in 3D, a portion of the presentation area 401 may be revealed. Any objects stored in this “backstage” area that were previously hidden by the work area 411 may now be exposed. The presentation area 401 may simply comprise a solid color background, unique from the colors of the work area 411. Alternatively, presentation area 401 may comprise a 3D table top (not shown), along which the work area may slide as it rotates away. In such a setting, the table top may comprise a flat mesh with reflective marble-like properties, and subsequently may create a mirrored reflection of the desktop.

The 3D engine optionally used to render each scene may take into account the visual perspective which occurs as objects move along the Z axis. Hence, objects that are closer to the user along the Z axis will appear larger to the viewer, and items further away along the Z axis will appear smaller. 3D perspective causes lines which are substantially parallel to appear to merge at some distant vanishing point on an invisible horizon. Thus, the portions of work area 411 which are further away will appear smaller in the frontal view of FIG. 5B, creating the trapezoidal effect most dramatically apparent with desktop 404. This helps solidify the 3D appearance of the work area 411 and presentation area 401 for the user, again helping to mentally decouple the applications of work area 411 from the operating system.

Once the work area 411 is rotated away, the program launcher 512 can appear in the portion of the presentation area revealed. FIG. 5A shows a top view of where program launcher 512 may be placed within the 3D presentation area 401. The distance from the user along the Z axis is not important, so long as the user can perceive and interact with the information component revealed. Here, program launcher 512 appears in the portion of the presentation area 401 revealed. Program launcher 512 may be animated into position, following the work area 411 as it moves away, or it may simply appear once the work area 411 has finished its arc, or it may fade into view.

Once program launcher 512 is revealed, the user may choose to launch one of the applications in the list of applications and submenus. A new application or new window for an existing application can be launched into work area 411 or into its own work area. Either way, program launcher 512 disappears, and work area 411 (or the new work area) returns to the forefront of the scene, preferably using a 3D animation. If the item selected from program launcher 512 is associated with the operating system, it may be launched as an information component in the same location as Start Menu 512. If the item selected from program launcher 512 requires the display of a submenu, then the program launcher remains, and work area 411 may be further transformed to make room for the submenu.

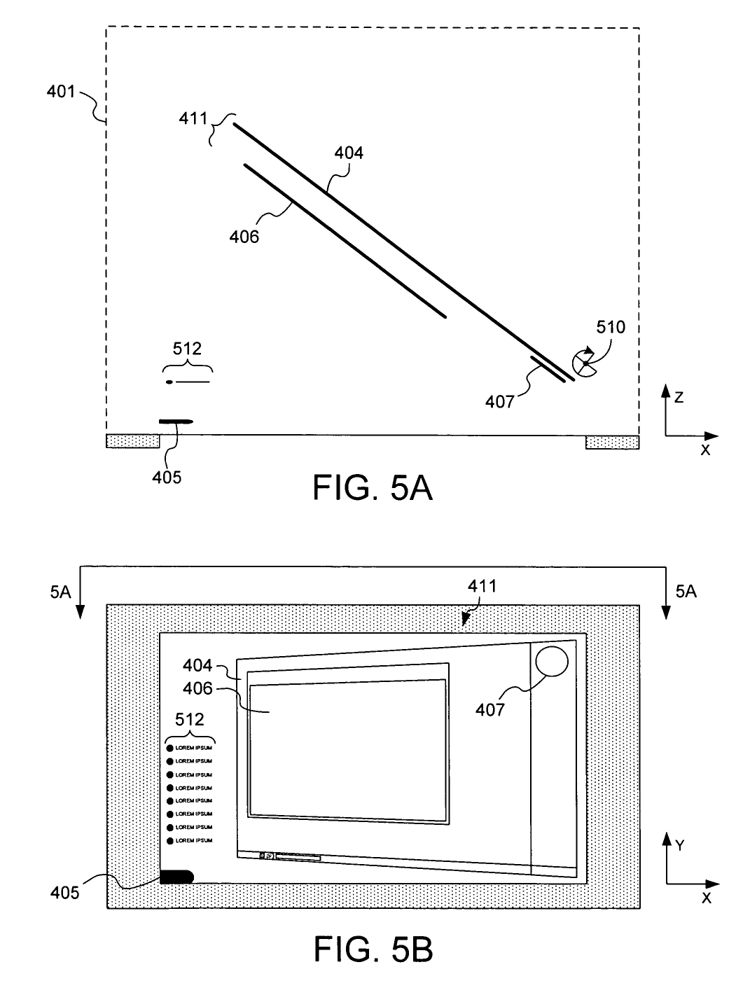

The submenu selection described above is depicted in FIG. 6A, which illustrates a top view of a virtual presentation area showing an illustrative embodiment of the invention. FIG. 6B illustrates a frontal view of the virtual presentation area of FIG. 6A as viewed by a user. Here, work area 411 has been further rotated away from the user around vertical axis 510. In the frontal view, this creates more room in which submenu 613 can be displayed. This same effect can be used for other information components which use this scheme, rotating the work area 411 back and forth depending on the amount of space needed. As before with the program launcher 512, once an item is selected in submenu 613, the submenu and program launcher may disappear, and work area 411 (or a new work area) may return to the forefront of the screen.

FIGS. 6A and 6B also provide an opportunity to examine the 3D rotational effect upon the components of work area 411. As desktop 404, open window 406, and dashboard item 407 are rotated away as a group, their positions along the X axis change relative to each other. This can be seen most clearly with desktop 404 and open window 406 in FIG. 6A. In the top view, desktop 404 and open window 406 remain in substantially the same position relative to each other as when the effect was begun (see FIG. 4A). However, because open window 406 is in front of desktop 404, the rotational transformation results in the open window appearing to shift to the left. This creates a raised effect for window 406 and dashboard item 407, enhancing the 3D perception of work area 411 for the user, and also helping the user to visualize the layering of windows within the work area.

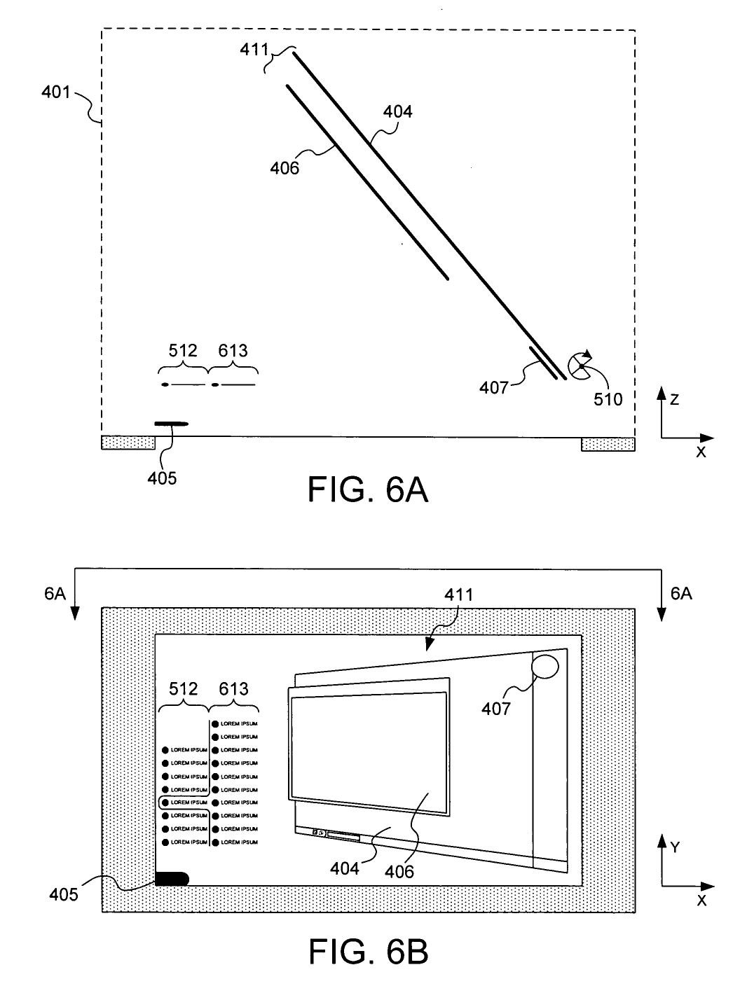

This 3D layering of windows in a work area is further depicted in FIG. 7A, which illustrates a virtual top view of a virtual presentation area showing an illustrative embodiment of the invention. FIG. 7B illustrates a frontal view of the virtual presentation area of FIG. 7A as viewed by a user. Here, work area 711 comprises desktop 704, and open windows 706a and 706b. Window 706a sits behind window 706b. When windows 706a, 706b are rotated with work area 711, their positions may change along the X axis relative to each other, enhancing their layered appearance. This 3D layering can be further emphasized through the use of shadows between windows (not shown), and the use of translucent window frames (not shown), which allow items behind the window frame to show through. Other 3D effects may also be used to enhance the 3D appearance of the work area 711.

If a user were to click on a portion of work area 711 rather than on the menu and submenu 712, as described above, the click may result in one of several events. The click may simply cause work area 711 to be transformed back to the forefront. Or the click location may be passed through to the work area and used appropriately. For example, if the user clicks on window 706a, not only may work area 711 return to the forefront, but window 706a may move to the top of the stack of open windows. Alternatively, clicking only once on window 706a may result in that window moving to the front of the stack, in front of window 706b, but work area 711 may remain transformed. In this scenario, a double click may be used to return work area 711 to the forefront.

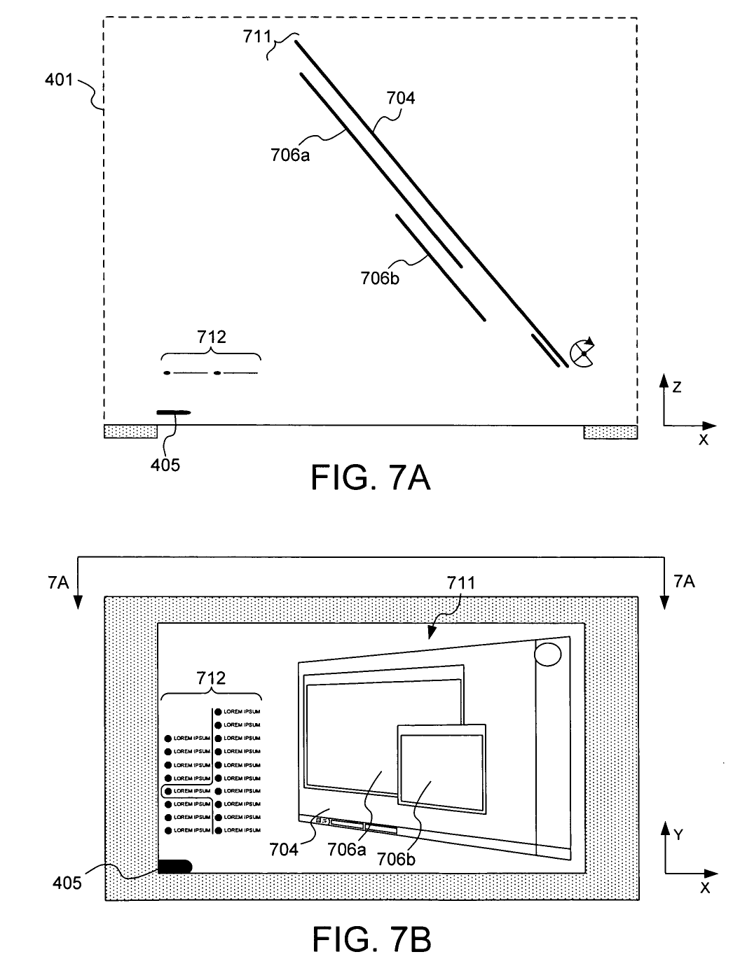

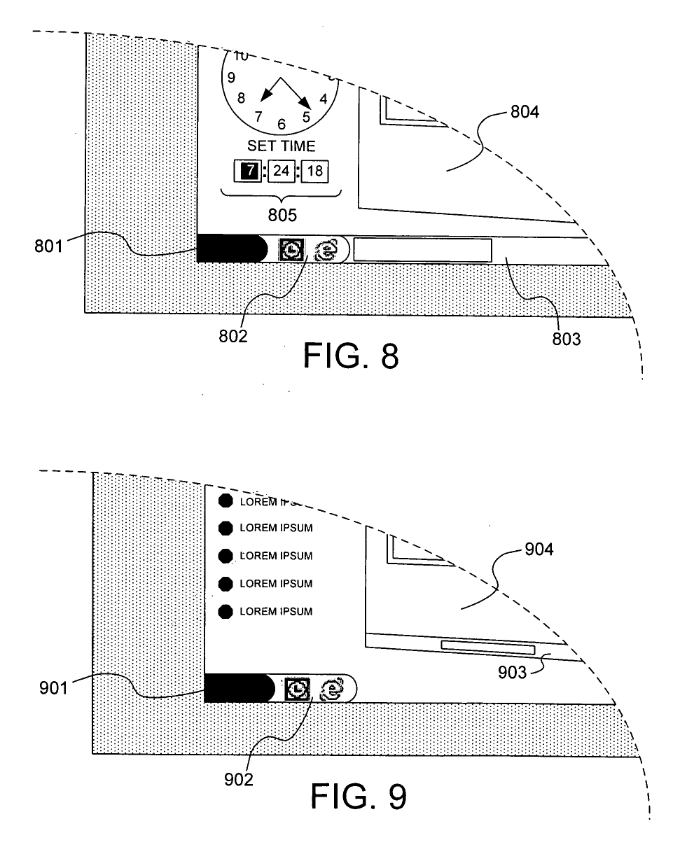

FIG. 8 illustrates a portion of a frontal view of an illustrative embodiment of the invention. Here, the information component 805 displayed in the portion of the presentation area revealed is a clock setting control. FIG. 8 further illustrates another illustrative embodiment where quick launch menu 802 and task bar 803 remain fixed on the display with Start button 801, rather than rotating away on desktop 804. FIG. 9 further illustrates a portion of a frontal view of an additional illustrative embodiment of the invention. Here, quick launch menu 902 remains with Start button 901, but task bar 903 rotates away with desktop 904.

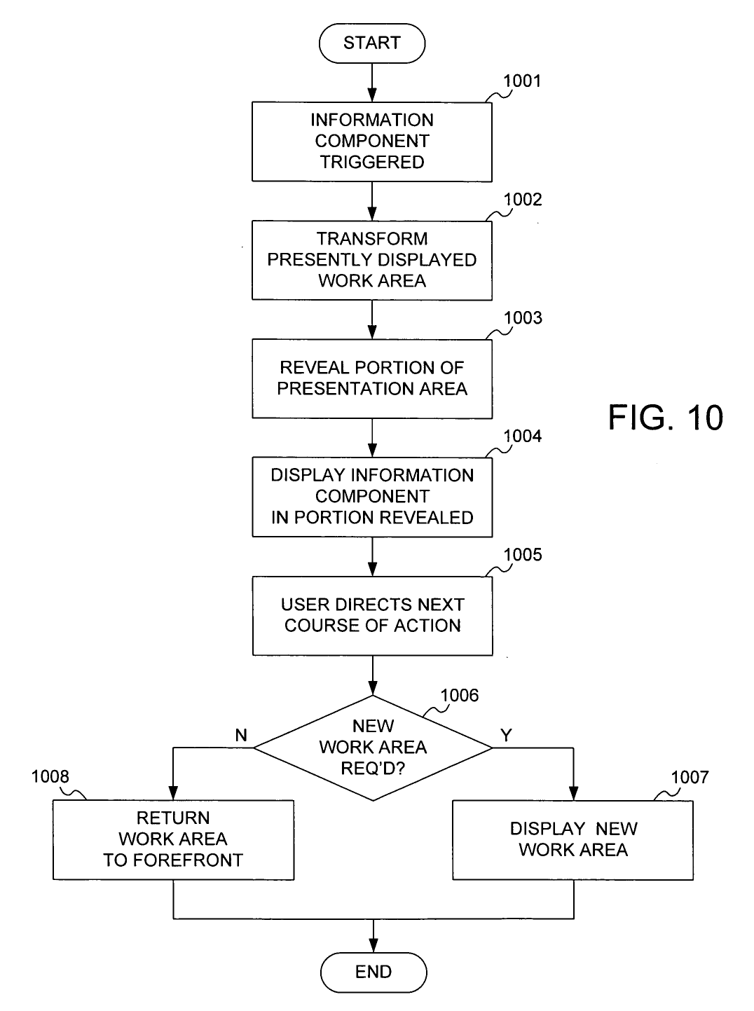

FIG. 10 illustrates a method for displaying an information component in a graphical user interface according to an illustrative aspect of the invention. The display of an information component is triggered in step 1001. This can occur as a result of the user clicking a Start button or launching an information component from a program launcher. Alternatively, the trigger may result from an application or operating system routine requiring the user to interact with or notice a particular information component. Once triggered, moving to step 1002, the presently displayed work area is transformed, either using 2D or preferably 3D graphical routines. In step 1003, a portion of the presentation area is revealed from behind the work area.

At this point, in step 1004, the information component required is displayed in the portion of the presentation area revealed. The user, in step 1005, controls the next course of action by directing input, such as a mouse click or keyboard stroke, to either the information component displayed or the recently transformed work area. Alternatively, the information component may be timed to retreat after a certain period of time. If the user's input requires a new work area in decision step 1006, then a new work area will be displayed in step 1007. Otherwise, if the user interacts directly with the transformed work area, or launches a new window in the transformed work area, then the information component may retreat, and the work area may return to the forefront.

Although the embodiments of the invention described herein make reference to their use in an operating system, this does not imply that additional embodiments cannot be used within an individual software application. Software programs such as word processors, games or database managers can benefit from displaying information components in this fashion.

While the invention has been described with respect to specific examples including presently preferred modes of carrying out the invention, those skilled in the art will appreciate that there are numerous variations and permutations of the above described devices and techniques that fall within the spirit and scope of the invention as set forth in the appended claims. For example, features described relating to the attachable templates and to determining locations of the inputs are applicable reciprocally between the template and the device.

We claim:

1. A method for displaying an information component to a user through a graphical user interface comprising the steps of:
(1) transforming a presently displayed work area to reveal a portion of a presentation area in which the work area is rendered;
(2) retaining interactivity within the work area; and
(3) displaying the information component in the revealed portion of the presentation area.

2. The method of claim 1, wherein step (1) comprises transforming the presently displayed work area using a three dimensional transform.

3. The method of claim 2, wherein step (1) further comprises using the three dimensional transform to rotate the presently displayed work area about an axis.

4. The method of claim 3, wherein step (1) further comprises rotating the work area away from the user around a vertical axis.

5. The method of claim 1, wherein step (1) comprises animating the transform of the presently displayed work area.

6. The method of claim 1, wherein step (1) comprises transforming a presently displayed desktop.

7. The method of claim 6, wherein step (1) further comprises transforming one or more open windows.

8. The method of claim 1, wherein step (1) comprises transforming a presently displayed application window.

9. The method of claim 1, wherein in step (3) the information component comprises a menu.

10. The method of claim 9, further comprising the steps of:
(4) transforming the presently displayed work area a second time to reveal a second previously unseen portion of the presentation area; and
(5) displaying a second menu in the second previously unseen portion of the presentation area.

11. The method of claim 1, wherein step (3) comprises displaying a Start Menu.

12. The method of claim 1, further comprising the steps of:
(4) receiving a user input directed to the transformed work area; and
(5) responding to the input in a similar manner as when the work area is not transformed.

13. The method of claim 1, wherein step (2) comprises allowing a user to direct input to the work area.

14. A computer system, comprising:
a pointing device for controlling the computer system;
a processor configured to provide a three-dimensional graphical user interface on a display device connected to the computer system by executing computer executable software modules stored in a memory of the computer; and
the memory storing computer executable software modules, the modules comprising:
a user interface software module configured to provide the graphical user interface displayed on the display device;
a graphical transformation software module configured to transform a displayed work area to reveal a portion of a presentation area, to retain interactivity within the work area, and to display an information component in the revealed portion of the presentation area.

15. The computer system of claim 14, wherein the graphical transformation software module is configured to transform the displayed work area using a three-dimensional transformation.

16. The computer system of claim 15, wherein the three-dimensional transformation comprises rotating the displayed work area around an axis.

17. The computer system of claim 16, wherein the axis comprises a vertical axis.

18. The computer system of claim 14, wherein the graphical transformation software module is configured to display a first menu in the revealed portion of the presentation area.

19. The computer system of claim 18, wherein the first menu comprises a program launch menu.

20. The computer system of claim 18, wherein the graphical transformation software module is further configured to transform the displayed work area a second time to reveal a second previously unseen portion of the presentation area, and to display a second menu in the second previously unseen portion of the presentation area.

21. The computer system of claim 20, wherein the second menu comprises a submenu of the first menu.

22. A computer readable medium storing computer executable instructions for a method for displaying an information component to a user through a graphical user interface, the method comprising steps of:
(1) transforming a presently displayed work area using a three-dimensional transform to reveal a portion of a presentation area behind the work area;
(2) retaining user interactivity within the work area; and
(3) displaying an information component in the revealed portion of the presentation area.

23. The computer readable medium of claim 22, wherein step (1) comprises transforming the presently displayed work area using the three-dimensional transform by rotating the work area away from the a user viewpoint around an axis.

24. The computer readable medium of claim 23, wherein the axis is a vertical axis.

25. A method for displaying a program launch menu to a user through a graphical user interface, comprising the steps of:
(1) rotating a presently displayed desktop using a three-dimensional transformation;
(2) revealing a portion of a presentation area based on step (1); and
(3) displaying the program launch menu in the revealed portion of the presentation area.

26. The method of claim 25, wherein step (2) comprises revealing one or more branding elements in the revealed portion of the presentation area.

27. The method of claim 25, wherein step (1) comprises rotating the presently displayed desktop around a vertical axis.

28. The method of claim 25, further comprising the step of:
(4) retaining interactivity in the transformed desktop as the desktop performed prior to step (1).

29. A method for providing a graphical user interface comprising:
(a) visually depicting a work area on a computer display screen;
(b) visually transforming the work area in a simulated three-dimensional presentation area to fill less than the entire display screen, thereby revealing a previously unseen portion of the simulated three-dimensional presentation area, wherein the work area remains visually depicted on the display screen;
(c) visually depicting an information component in the revealed portion of the simulated three-dimensional area.

30. The method of claim 29, wherein step (b) comprises using a simulated three-dimensional transformation.

31. The method of claim 30, wherein the simulated three-dimensional transformation comprises simulating the desktop rotating away from a user perspective.

32. The method of claim 29, wherein step (c) comprises depicting a menu.

33. The method of claim 32, wherein in step (c) the menu comprises a program launch menu.

34. The method of claim 29, wherein in step (c) the information component comprises at least one of a clock, a file manager, an application un-installer, a task manager, a network dialog, and a printer dialog.

35. The method of claim 29, further comprising, subsequent to transforming the work area, receiving user input in the work area.
